(19) United States
(12) Patent Application Publication
(10) Pub. No.: US 2009/0130968 A1
(43) Pub. Date: May 21, 2009

(54) Device for Influencing an Airflow

(75) Inventors: Martin Harich, Ludwigsburg (DE); Georg Kaemmler, Stuttgart (DE); Ulrich Vollert, Stuttgart (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: BEHR GMPH & CO., KG

(21) Appl. No.: 11/817,107

(22) PCT Filed: Jan. 16, 2006
(86) PCT No.: PCT/EP2006/000308

§ 371 Date: Dec. 6, 2007

(30) Foreign Application Priority Data
Feb. 25, 2005 (DE) 10 2005 009 203.9

(51) Int. Cl. B60H 1/30; B32B 37/12; B29C 45/14

(52) U.S. Cl. 454/148; 156/60; 264/259

(57) ABSTRACT

The invention relates to a device for influencing or regulating an air flow for a motor vehicle, the device comprising a flexible film element (8) provided with a plurality of openings for the passage of an air flow, and a rigid carrying element (9) on which the film element (8) is held, the film element (8) comprising a plurality of flap elements (7) which correspond to the openings and are defined by a flap edge (7a) which penetrates the film element (8) and only partially surrounds the flap element (7). The aim of the invention is to produce a device for regulating an air flow for a motor vehicle that can be economically produced and has a high durability with a low susceptibility to dirt accumulation. To this end, the carrying element (9) has flat regions (9a) and openings, the openings being associated with the flap elements (7) for the passage of the air flow. The film element (8) is arranged on the flat regions (9a).

### CROSS-REFERENCES TO RELATED APPLICATIONS

This application is a National Stage filing of International Application PCT/EP2006/000308, filed Jan. 16, 2006, claiming priority to German Application No. 10 2005 009 203.9 filed Feb. 25, 2005, entitled “DEVICE FOR INFLUENCING AN AIRFLOW”. The present application claims priority to PCT/EP2006/000308, and to German Application No. 10 2005 009 203.9, and both references are expressly incorporated by reference herein, in their entireties.

### BACKGROUND OF THE INVENTION

The invention concerns a device for influencing or regulating an air flow according to the preamble of claim 1 as well as a method for the production of such a device.

In motor vehicles the use of ram pressure flaps in air passages is well-known. Ram pressure flaps are understood in general to be flaps limiting or closing off the air passage, which are opened when an air pressure difference is present. The air pressure difference can result from a wind blast. Flaps which are held individually and rigidly in a respective articulated mechanism, usually a pivot joint, are used in modern automobile manufacturing. This results in costs and expenditure of time in the production of appropriate shrouds furnished with ram pressure flaps. Moreover, the joint mechanisms are susceptible to contamination and wear. Furthermore, the opening resistance of such flaps is usually high and not constant over the service life.

U.S. Pat. No. 2,205,661 describes a cover for a motor vehicle heat exchanger, which is produced substantially from a rubber material and can be inserted by means of integrally formed connecting fingers thereon between fixation ridges of the heat exchanger. The cover in this case comprises a number of rubber flaps, which can be bent flexibly in an opening direction by the wind blast.

The problem of the invention is to create a device for influencing or regulating an air flow for a motor vehicle that can be produced economically and has low susceptibility to contamination and a long service life. It is additionally the problem of the invention to specify a method for producing such a device.

This problem is solved by the device according to the invention mentioned above with the characteristic features of claim 1.

By combining a support element and a film component together with a flat connection of the two, a shroud can be economically constructed that already has several flap elements, which, due to their formation from film, additionally are free-moving, insensitive to contamination, long-lived and relatively light weight. Further advantages are a cost reduction due to reduced installation expense and material savings. Compared to comparable mechanical flaps, an improved cooling performance can be attained because of better sealing of the flaps, easier opening and a more versatile geometrical adjustment. More automated manufacturing is also possible owing to the nature of the device, so that a uniform and higher quality is possible. Moreover, rattling noises, such as those that occur, for instance, when vehicle doors are closed, are reduced as compared to flaps with a mechanical joint.

The film element consists of a plastic, in particular, partially-aromatic polyamide, polytetrafluorethylene (PTFE), perfluoroalkoxy copolymers (PFA), PVC, polypropylene (PP) or polyimide (PI), or of multilayer films with preferably at least one of the above materials, of elastomer, or fabric or coated fabric or from an oriented (stretched) film. Because of the materials mentioned, long service lives and low susceptibility to abrasion can be attained. It is particularly preferred for the carrying element as well to consist of a plastic, in particular, additive-reinforced polypropylene (PP) or Polyamide 66 (PA66), whereby an easy formation method and simple production for the device become possible.

The flap elements are advantageously backed with a reinforcement made from the material of the carrying element. It is further advantageous if the film is supported with a grid that covers the opening in the carrying element. This allows the film to be formed particularly thin and easily manufactured, so that the resistance of the film hinge is especially low.

Preferably, a fan shroud for holding a fan in a suction arrangement relative to a heat exchanger is formed, wherein a suction operation of the fan brings about a pressure difference acting in the closing direction of the flaps, and wherein a speed-induced wind blast brings about a pressure difference acting in the opening direction of the flaps. In this manner, both a smooth running opening of the flap elements as well as good integrity under a pressure load in the closing direction can be used to improve known devices.

In an advantageous embodiment, the film element can be connected to the carrying element by means of an adhesion-promoting intermediate layer, in particular a glue, whereby easy manufacture is made possible. Alternatively or additionally, the film element can also have openings through which the parts of the carrying element penetrate the film element for fixation. This enables a particularly secure form-fitting or undercutting fixation of film element and carrying element. Once again, alternatively or additionally, an adhesive direct connection of the materials of the film element and a carrying element can be present in the area of their surface contact, which, of course, usually requires special manufacturing, but guarantees a particularly reliable and secure connection of the elements. Such a direct connection can be achieved, for instance, by injection molding the carrying element onto the film. In order to achieve areas of mutual fixation, together with areas of non-adhesion, a local pre-treatment of the surface of at least one of the elements can be performed. Depending on the requirement, the material and the type of pretreatment, the pretreated sites can then be adhesive or non-adhesive. It is further advantageous if an adhesive intermediate layer is used, which is adhesive or non-adhesive after pretreatment.

In a preferred embodiment of a device according to the invention, at least two flap elements are of different sizes, whereby the ram pressure impinging on the one flap element has a different magnitude than the ram pressure impinging on the other flap element.

By adapting the individual flap elements in size and shape to a three-dimensional ram pressure distribution, such as that appearing between a heat exchanger and a fan shroud, a further optimization of the airflow rate is possible since an earlier opening of the respective flap is achieved.

The problem is solved by the method according to the invention with the characteristics of claim 21.

In an advantageous configuration of the method, an adhesive is applied before the connection of the film element and the carrying element to at least one of the two. This allows manual or automatic manufacturing, which is profitable even for small series runs.

Before the connection of the film element and the carrying element, an at least partial surface treatment, in particular, a plasma treatment, of at least one of the two, film element or carrying element, is particularly preferred. The plasma treatment is advantageous if the part to be treated, preferably the film, is treated before the injection molding onto it from the rear is performed. In this way, a direct connection, in the ideal case with molecular polymerization of the two elements frequently consisting of different plastics, can be achieved. Alternatively or additionally, the film element and or the carrying element can be furnished with an anti-adhesive layer before the connection; this is particularly of interest if the two materials adhere to one another or will undergo a connection. Quite generally speaking, one can thereby achieve a well-defined separation of areas of the elements which are to be detached from one another after production.

In a particularly preferred embodiment of the method of the invention, the carrying element is injection-molded onto the film element after the film element has been placed into an injection mold. In this manner, the device can be produced economically, in large series runs and with very uniform quality.

Reinforcements of the flap elements are advantageously molded onto it by means of injection channels in the manner of a tunnel molding, so that no additional expense is incurred, even if a large number of flap elements are formed.

In a further preferred embodiment, the film separation is introduced by a shearing edge formed in the injection mold, so that pressure applied by the injection molding of the carrying element onto the film element leads its being punched through or incised in a simple manner.

Alternatively, the film separation can be implemented by a shearing tool after molding the carrying element. In another alternative, the flap elements can be formed by processing with a laser beam after the carrying element has been injected molded onto them. The selection of the methods for forming the flap elements depends entirely on the type of material and material thickness, as well as additional requirements.

Depending on requirements, the film separation can be performed on the film element even before a connection to the carrying element. This is particularly advisable if the carrying element is not molded on, but instead the two elements are connected by adhesion, for instance.

Additional advantages and characteristics follow from the dependent claims, as well as from the embodiments described below.

A preferred embodiment of a device according to the invention, along with modified embodiments regarding the manufacturing method will be described below and explained in detail on the basis of the appended drawings.

### BRIEF SUMMARY

The invention relates to a device for influencing or regulating an air flow for a motor vehicle, the device comprising a flexible film element (8) provided with a plurality of openings for the passage of an air flow, and a rigid carrying element (9) on which the film element (8) is held, the film element (8) comprising a plurality of flap elements (7) which correspond to the openings and are defined by a flap edge (7a) which penetrates the film element (8) and only partially surrounds the flap element (7). The aim of the invention is to produce a device for regulating an air flow for a motor vehicle that can be economically produced and has a high durability with a low susceptibility to dirt accumulation. To this end, the carrying element (9) has flat regions (9a) and openings, the openings being associated with the flap elements (7) for the passage of the air flow. The film element (8) is arranged on the flat regions (9a).

### BRIEF DESCRIPTION OF THE SEVERAL VIEWS OF THE DRAWINGS

FIG. 1 shows a view from behind, or in the direction of travel, onto a fan shroud with a device according to the invention, wherein the right half shows an arrangement according to the prior art, and the left upper half, as well as the left lower half, shows respective modifications of the device according to the invention.

FIG. 2 shows a flap element of a device according to the invention in an approximately closed, a half-opened and an approximately opened state.

FIG. 3 shows a device according to the invention in an injection mold to illustrate a first embodiment of a manufacturing method according to the invention.

FIG. 4 shows a device according to the invention in an injection mold in order to illustrate a second embodiment of a new manufacturing method according to the invention.

FIG. 5 shows the device from FIG. 4 upon opening the injection mold after casting.

FIG. 6 shows a diagram illustrating the travel speed-dependent airflow rate as improved by a device according to the invention.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

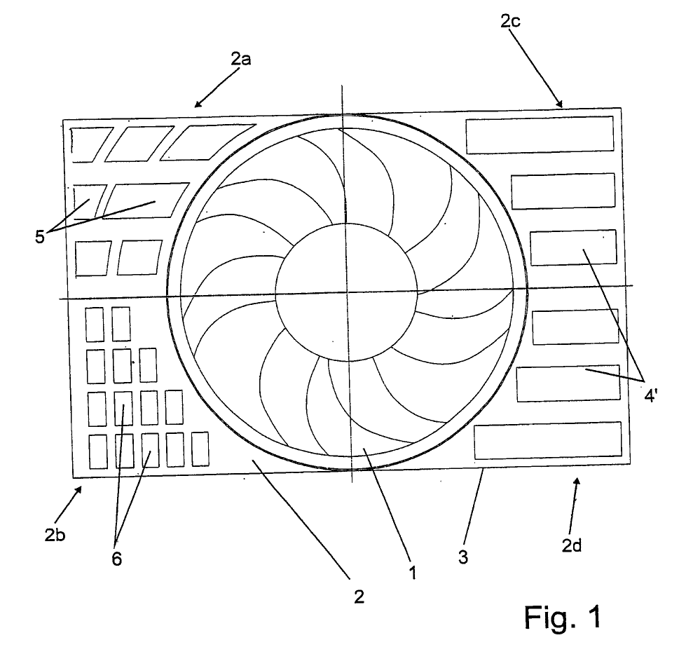

The device shown in FIG. 1 comprises an electric fan 1, which in suction operation is arranged in front of a heat exchanger, not visible, in the direction of travel. Fan 1 is housed in a fan shroud 2, which is joined airtight to the heat exchanger along its edges 3. This connection can be accomplished directly or by means of an intermediate frame or by other means.

For reasons of simplified illustration, fan shroud 2, as shown, has four sectors 2a, 2b, 2c, 2d, each of which corresponds to roughly one fourth of the fan shroud. Right-hand sectors. 2c, 2d are identical and schematically show elongated, rectangular or relatively large-surface flap elements or ram pressure flaps 4′. These ram pressure flaps 4′ correspond to the prior art and are constructed as flaps with a mechanical joint. This representation of prior art illustrates that conventional mechanical flaps 4′ are usually small in number, in order not to cause excessive expense, and are usually rectangular.

Ram pressure flaps 5, 6 of sector 2a (upper left), as well as those of sector 2b (lower left) are each variations of ram pressure flaps according to the present invention.

Flap elements 5 of sector 2a each have at least two opposing non-parallel edges, one of the edges even being curved. The flap elements 5 that are closer to fan 1 are larger than those in the peripheral area. This distribution and shaping is not arbitrary, but is adapted to a spatial ram pressure distribution between heat exchanger and fan shroud, which is caused by the wind blast. Because of this adaptation, some of these flaps open earlier than the other flaps, so that an improved airflow rate is achieved even at slow speeds. Thus, driving situations can result in which the fan can run at reduced power, so that energy is also saved by the arrangement.

A different arrangement is shown in sector 2b. The flap elements 6 according to the invention are each rectangular and very small; a large number of such elements is used to achieve a good airflow rate. This illustrates the high flexibility of the device according to the invention, since the number, size and shape of the flap elements make no significant difference in terms of cost and effort.

All the ram pressure flaps shown in FIG. 1 are opened by the wind blast coming out of the plane of the paper, while the operation of the fan when the vehicle is stationary, or at low speeds, brings about a reduced air pressure between fan shroud 2 and the heat exchanger (suction operation), so that in this case, the ram pressure flaps are subjected to pressure in the closing direction.

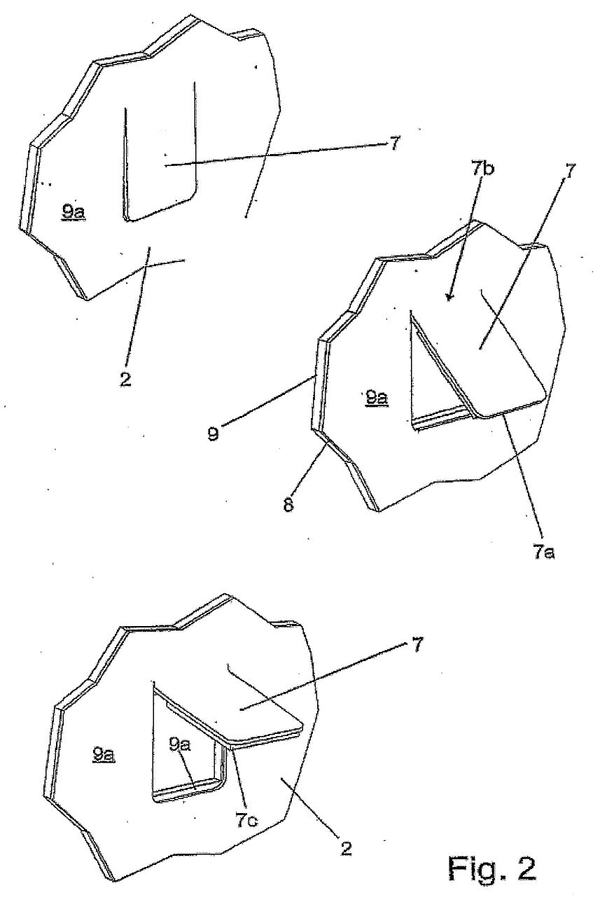

The representation in FIG. 2 shows a cutout from fan shroud 2 of FIG. 1 with a single flap element 7 according to the invention in different positions. The device comprises a film element 8 and a carrying element 9, which lie flat against one another in large areas 9a, more specifically, adhering to one another. Flap element 7 has a flap edge 7a, which is formed as a cutting or penetration of film element 8. Flap edge 7a surrounds the substantially rectangular flap element 7a on only three sides. The fourth side is not cut through, so that the film there forms a film hinge 7b for the movement of the flap. The film can expediently also be attenuated on this side, for instance, by scribing or stamping.

Behind the film, flap element 7 has a has a reinforcement 7c, expediently consisting of the same material as carrying element 9, with edge 7a extending past reinforcement 7c. This excess length of edge 7a corresponds to an excess length 9a of carrying element 9 in the opening of flap element 7, which lies in an opening of carrying element 8, so that the rim of the flap element strikes against or stops at excess length 9a in the closed state. A good tightness of flap element 7 is also guaranteed thereby

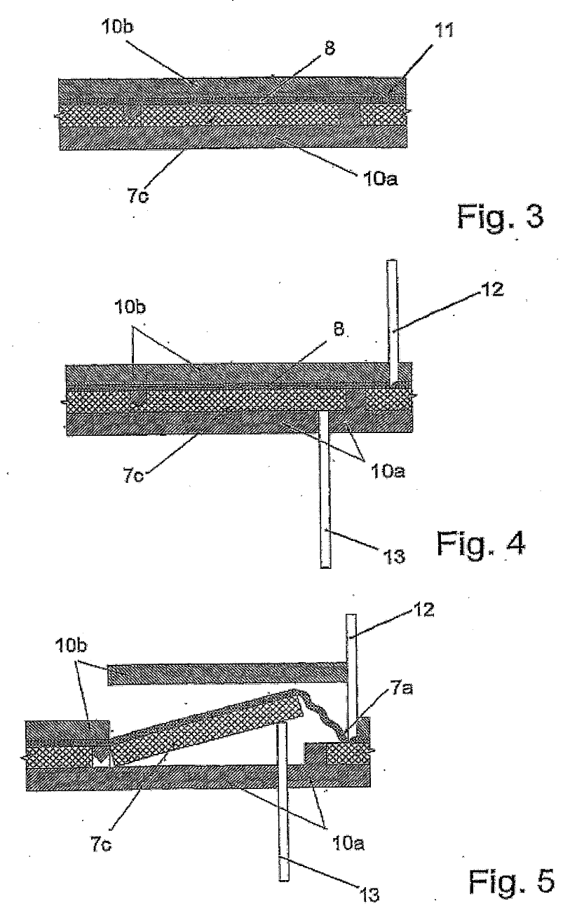

In the described embodiment, carrying element 9 is molded onto film element 8 in a tool, or an injection mold comprising two injection mold halves 10a, 10b (see FIGS. 3-5). Care is taken that only those areas of the film that do not hinder the opening of the flap elements are adhered to the carrying element. This is done in the present case by surface treatment of the film elements, wherein in particular, a separating agent or an anti-adhesion layer is applied specifically to these areas.

The areas of film 8 intended for mutual adhesion undergo a direct polymerization with the material of the carrying element during the injection molding of carrying element 9. Depending on the material pair, a previous surface treatment of the film can be provided, by plasma treatment, for instance.

Particularly for fan shrouds with a very bent shape, film element 8 is precisely fitted into the injection mold before carrying element 9 is molded on.

The material of the carrying element in the present case is Polyamid 66, which has added glass fibers for mechanical reinforcement. The film material can expediently likewise be a polyamide. In particular, the film material can contain additives such as plasticizers, which ensure high film flexibility.

Reinforcements 7c are likewise applied in the course of being injected molded onto the film. The application is done by means of defined injection channels in a similar manner as in tunnel molding. Any ridges or connections of flap elements 8 to carrying element 9 are removed at the latest when the injection mold is opened.

Edge area 7a of flap elements 7 is generally formed only during or after molding. There are various alternatives to this, of which three are illustrated in FIGS. 3-5.

In the case of FIG. 3, a sharply pointed nose or shearing edge 11 is formed on an upper part 10b of the injection mold. During the injection of carrying element 9, a high pressure is exerted on film element 8, so that the film is cut through or at least cut into on the shearing edge. If desired, a manual or automatic separation of the incision can take place, perhaps by pressing flap elements 7 inward after the opening of the tool.

In the case of FIG. 4, the film is at first intact after carrying element 9 is injection-molded onto it. Then an appropriate shearing tool 12 moves into the molding tool and incises the edge region starting from the side of the film turned away from the carrying element. For separation, another tool 13 moves, in accordance with FIG. 5, from the opposite underside against reinforcements 7c of flap elements 7, in order at the same time to push up flap elements 7 simultaneously with the opening of the upper part 10b of the injection mold. In this pushing-up movement, the flap elements tear off from the remainder of the film at the position of the cutting tool. Depending upon the design and adjustment of the tools, a lengthening of the film can thereby take place in the boundary region 7a. This is represented in exaggerated form in FIG. 5. A particularly good sealing edge region 7a can be obtained in this way.

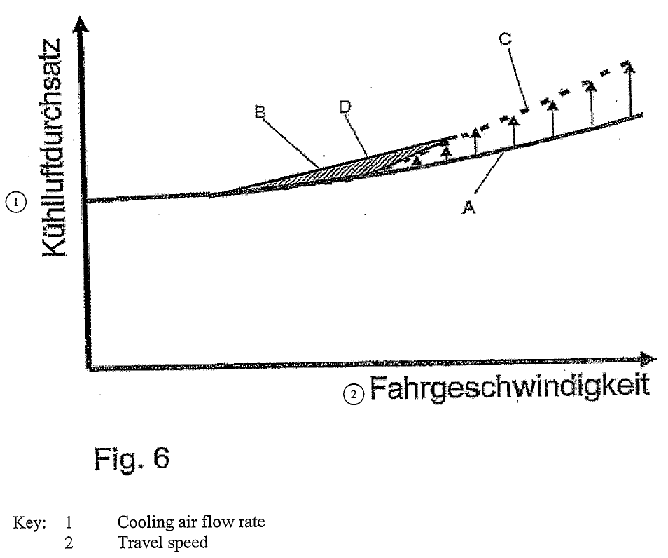

Altogether a reduced flap resistance and thus an improved air flow rate can be obtained with the device according to the invention, particularly in the lower speed range. As an illustration, the diagram in accordance with FIG. 6 shows the cooling air flow rate versus travel speed. The lower solid line A shows the actual air volume without ram pressure flaps. The upper solid line B shows the air volume ram with pressure flaps of a device according to the invention. The hatch-marked square marks the improvement from film pressure flaps versus conventional ram pressure flaps due to a subdivision adapted to the shroud pressure profile. The broken line C shows a theoretical optimum for the air flow rate with conventional ram pressure flaps, which deviates increasingly from the curve A at higher travel speed.

The hatched area D illustrates the distance between the curves B and C and thus relates to the possible improvement from the device according to invention, or flap elements, versus known ram pressure flaps.

While the preferred embodiment of the invention has been illustrated and described in the drawings and foregoing description, the same is to be considered as illustrative and not restrictive in character, it being understood that all changes and modifications that come within the spirit of the invention are desired to be protected.

1-31. (canceled)

32. Device for influencing or regulating an airflow for a motor vehicle, comprising
a flexible film element (8) with a plurality of openings for passing an airflow, and
a preferably rigid carrying element (9) on which film element (8) is held,
wherein, corresponding to the openings, film element (8) has a plurality of flap elements (7), each of which is defined by a flap edge (7a) penetrating film element (8) and not completely surrounding flap element (7),
characterized in that
carrying element (9) has flat areas (9a) and openings, wherein the openings are associated with flap elements (7) for passing the airflow and wherein film element (8) lies flat against flat areas (9a).

33. Device according to claim 32, characterized in that film element (8) material is selected from the choices of a partially aromatic polyamide, polytetrafluoroethylene (PTFE), perfluoroalkoxy copolymer (PFA), PVC, polypropylene (PP) or polyimide (PI).

34. Device according to claim 33, characterized in that the film element is stretched.

35. Device according to claim 32, characterized in that carrying element (9) likewise consists of a polypropylene (PP) material.

36. Device according to claim 32, characterized in that at least one of the flap elements (7) is backed with a reinforcement (7C).

37. Device according to claim 32, characterized in that a fan shroud (2a, 2b) for housing a fan (1) in a suction arrangement relative to a heat exchanger is formed from the device, wherein a fan-dominated operation brings about a pressure difference acting in the closing direction of flap elements (7), and wherein a wind blast-dominated operation brings about a pressure difference acting in the opening direction of flap elements (7).

38. Device according to claim 32, characterized in that film element (8) is connected to carrying element (9) by means of an adhesion promoting intermediate layer.

39. Device according to claim 38, characterized in that deactivation is performed by means of plasma or flaming.

40. Device according to claim 32, characterized in that film element (8) has openings through which parts of carrying element (9) penetrate film element (8) for purposes of fixation.

41. Device according to claim 32, characterized in that an adhesive direct connection of the materials of film element (8) and carrying element (9) is present in the area of their flat area contact (9a).

42. Device according to claim 32, characterized in that at least two of the plurality of flap elements (7) are of different size.

43. Device according to claim 42, characterized in that the ram pressure appearing at the one flat element likewise has a different magnitude than the ram pressure appearing simultaneously at the other flap element (7).

44. Device for influencing an airflow with at least two flap elements, according to claim 32, characterized in that the flap elements are constructed and arranged for permitting an opening dependent on the local pressure relationships.

45. Device according to claim 44, characterized in that an opening dependent on the local pressure relationships means that at least individual flap elements are opened and others are closed.

46. Device according to claim 32, characterized in that the flap element is constructed free of any carrying structure.

47. Device according to claim 46, characterized in that the flap element is formed only as film.

48. Device according to claim 32, characterized in that the flap element has a structure formed in the film constructed and arranged for increasing unidirectional or bidirectional strength.

49. Device according to claim 32, characterized in that in a hinge region, the flap element has an attenuated flexible structure that is generated by incision or stamping.

50. Device according to claim 32, characterized in that printed conductors are provided in cooperation with the film.

51. Device according to claim 32, characterized in that an opening recognition of the flaps can be performed by means of sensors.

52. Method for producing a device according to claim 32, comprising the following steps:
a. preparing film element (8) by means of a conventional method for producing a film; and
b. connecting film element (8) to carrying element (9).

53. Method according to claim 52, characterized in that before the connection of film element (8) and carrying element (9), an adhesive is applied to at least the film element (18) or the carrying element (9).

54. Method according to claim 52, characterized in that before the connection of film element (8) and carrying element (9), at least a partial surface treatment, in particular, a plasma treatment of at least the film element (8) or the carrying element (9) is performed.

55. Method according to claim 52, characterized in that before the connection of film element (8) and carrying element (9), at least the film element (8) or the carrying element (9) is furnished at least locally with an anti-adhesion layer so that no connection arises at these positions.

56. Method according to claim 52, characterized in that the carrying element is injection-molded onto the film element after the placement of film element (8) into an injection mold (10a, 10b).

57. Method according to claim 56, characterized in that reinforcements (7c) of the flap elements are formed by injection molding by means of injection channels, in the manner of a tunnel casting.

58. Method according to claim 56, characterized in that flat edges (7a) of flap elements (7) are formed in film element (8) by a shearing edge (11) formed in injection mold (10a, 10b).

59. Method according to claim 56, characterized in that flap elements (7) are formed by a shearing tool after the injection molding of carrying element (9).

60. Method according to claim 56, characterized in that flap elements (7) are formed by machining with a laser beam after the injection molding of carrying element (8).

61. Method according to claim 56, characterized in that flap elements (7) are formed in film element (8), particularly by means of punching, before a connection to carrying element (9).

62. Method according to claim 52, characterized in that the film element is thermally formed before introduction into the injection molding tool, or in the injection molding tool.
